(19) United States
(12) Patent Application Publication
(10) Pub. No.: US 2014/0176805 A1
(43) Pub. Date: Jun. 26, 2014

(54) IMAGE DISPLAY DEVICE AND METHOD OF STARTING THEREOF

(71) Applicant: Kabushiki Kaisha Toshiba, Tokyo (JP)

(72) Inventor: Koichiro Matsuda, Ome-shi (JP)

(73) Assignee: Kabushiki Kaisha Toshiba, Tokyo (JP)

(21) Appl. No.: 14/011,557

(22) Filed: Aug. 27, 2013

Related U.S. Application Data
(63) Continuation of application No. PCT/JP2013/058147, filed on Mar. 21, 2013.

(30) Foreign Application Priority Data
Dec. 26, 2012 (JP) 2012-283113

(51) Int. Cl. H04N 5/63

(52) U.S. Cl. CPC H04N 5/63
USPC 348/730

(57) ABSTRACT

Disclosed is an image display device capable of starting in accordance with a preference of a user, and starting method thereof. According to an embodiment, an image display device includes a control section and a storage section. The control section correlates a non-power button provided on a remote controller with a startup mode of the image display device set by the user. The storage section saves information on the correlation established by the control section.

### CROSS REFERENCE TO RELATED APPLICATIONS

This application is a Continuation Application of PCT Application No. PCT/JP2013/058147, filed Mar. 21, 2013 and based upon and claiming the benefit of priority from Japanese Patent Application No. 2012-283113, filed Dec. 26, 2012, the entire contents of all of which are incorporated herein by reference.

### FIELD

Embodiments described herein relate generally to an image display device and method of starting thereof.

### BACKGROUND

When a television receiver makes a transition from a startup state to a standby state, the receiver maintains the operation mode (e.g., sound volume, channel, and the like) immediately before the transition. Normally, when a user starts a television receiver in a standby state, the user depresses a power button of a remote controller (hereinafter referred to as a remote control). Then, when the television receiver makes a transition from the standby state to the startup state, the receiver starts in the maintained operation mode.

However, it is not always convenient for the user to start the television receiver in the operation mode maintained by the receiver as it is. For example, the user must carry out a troublesome operation of depressing the buttons of the remote control a plurality of times after starting the television receiver in order to set a desired channel, sound volume or the like. Further, there is the possibility of the television receiver being started in an operation mode of high sound volume as it is despite the midnight.

In order to eliminate such inconvenience, it is conceivable that addition of a hardware resource capable of inputting a startup mode at the time of starting a television receiver to the remote control may be employed. However, addition of a hardware resource is not desirable in terms of the cost and size.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram schematically showing a television receiver which is an example according to an embodiment.

FIG. 2 is an external view of a remote control which is an example according to the embodiment.

FIG. 3 is a flowchart of processing of assigning a startup mode to a button other than the power button, the processing being an example according to the embodiment.

FIG. 4 is an assignment setting screen view which is an example according to the embodiment.

FIG. 5 is a flowchart of startup processing of the television receiver, the processing being an example according to the embodiment.

FIG. 6 is a view for explaining the startup processing which is the example according to the embodiment.

### DETAILED DESCRIPTION

Disclosed are embodiments relating to an image display device capable of starting in accordance with the preference of a user, and starting method thereof. In general, according to one embodiment, an image display device includes a control section and a storage section. The control section correlates a non-power button provided on a remote controller with a startup mode of the image display device set by the user. The storage section saves information on the correlation established by the control section.

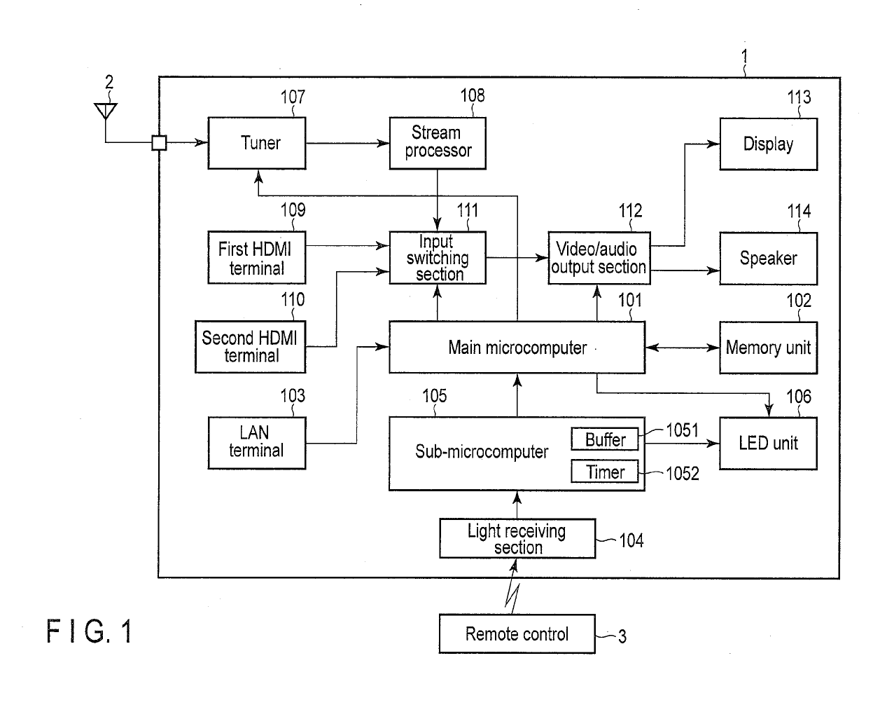

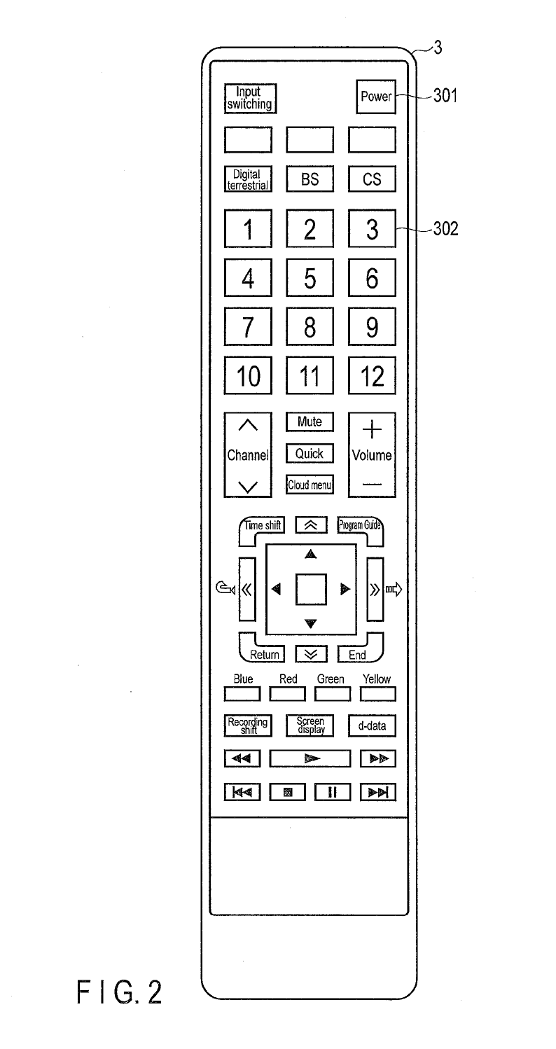

Hereinafter, an embodiment will be described with reference to the drawings. FIG. 1 is a block diagram schematically showing a television receiver 1 (image display device) which is an example according to the embodiment. FIG. 2 is an external view of a remote control 3 which is an example according to the embodiment. The television receiver 1 is provided with a main microcomputer 101, memory unit 102, local area network (LAN) terminal 103, light receiving section 104, sub-microcomputer 105, light emitting diode (LED) unit 106, tuner 107, stream processor 108, first high definition multimedia interface (HDMI) terminal 109, second HDMI terminal 110, input switching section 111, video/audio output section 112, display 113, and speaker 114.

The main microcomputer (control means) 101 controls each element in the television receiver 1. The main microcomputer 101 controls, for example, channel switching, sound volume adjustment, and the like in accordance with a key code which is information corresponding to a depressed button (key) of the remote control 3. The main microcomputer 101 is a microcomputer configured to stop an operation thereof when the television receiver 1 is in a standby state. In this embodiment, it is assumed that a standby state implies a state where only the sub-microcomputer 105 operates, and operations of other elements of the television receiver 1 stop as will be described later. It is also assumed that a state where the main microcomputer 101 operates is called a startup state.

The memory unit 102 is provided with a ROM storing therein a control program to be executed by the main microcomputer 101, and nonvolatile memory or the like in which various information items are saved. The memory unit 102 is used by the main microcomputer 101 to store therein information or is used by the main microcomputer 101 to read the information therefrom.

The LAN terminal 103 is a terminal configured to make a connection to the Internet through a LAN. Information from the Internet through the LAN terminal 103 is supplied to the main microcomputer 101.

The light receiving section 104 is an interface configured to receive a key code corresponding to a depressed button on the remote control 3 used to control the television receiver 1. The light receiving section 104 supplies the key code to the sub-microcomputer 105.

The sub-microcomputer (control means) 105 is a microcomputer in an activated state even when the television receiver 1 is in a standby state. That is, the sub-microcomputer 105 waits for depression of a button provided on the remote control 3 even when the television receiver 1 is in the standby state. Here, as shown in FIG. 2, the remote control 3 is provided with a plurality of buttons such as a power button 301 configured to bring the television receiver 1 to a startup state, channel buttons 302, and the like which can be depressed by the user. When the television receiver 1 is in the startup state, the sub-microcomputer 105 supplies the received key code to the main microcomputer 101. On the other hand, when the television receiver 1 in the standby state, if a key code corresponding to the power button 301 is received, the sub-microcomputer 105 transmits a startup instruction to the main microcomputer 101 the operation of which is stopped to thereby start the main microcomputer 101. Furthermore, when the television receiver 1 is in the standby state, if a key code other than the key code corresponding to the power button 301, i.e., a key code corresponding to a button other than the power button 301 is received, the sub-microcomputer 105 saves the key code in a buffer 1051 with which the sub-microcomputer 105 is provided. The sub-microcomputer 105 supplies a key code corresponding to a button of the remote control 3 other than the power button 301, and saved in the buffer 1051 to the main microcomputer 101 on the basis of a predetermined condition as will be described later. It should be noted that the sub-microcomputer 105 is also provided with a timer 1052 for timing.

The LED unit (notification means) 106 is an indicator to be turned on, turned off or blinked by the control of the sub-microcomputer 105 or the main microcomputer 101. For example, when the LED unit 106 is provided with only LEDs of a single color, the LED unit 106 is in the off-state when the television receiver 1 is in the standby state, and is in the on-state when the television receiver 1 is in the startup state. For example, when the LED unit 106 is provided with LEDs of a plurality of colors such as red, blue, and the like, in the LED unit 106, a red LED is turned on when the television receiver 1 is in the standby state, and blue LED is turned on when the television receiver 1 is in the startup state.

The tuner 107 is a digital broadcast receiving tuner. The tuner 107 subjects a digital broadcast signal received by the antenna 2 to channel selection on the basis of a user operation. The tuner 107 demodulates a digital broadcast signal, and supplies the demodulated signal to the stream processor 108.

The stream processor 108 extracts various digital signals from the demodulated digital broadcast signal, and supplies a video signal, and audio signal to the input switching section 111.

Each of the first HDMI terminal 109, and second HDMI terminal 110 is an external input terminal by which an external device (e.g., a game machine, DVD player or the like) can be connected to the television receiver 1 through an HDMI cable.

A video signal or an audio signal from the external device through the first HDMI terminal 109 or the second HDMI terminal 110 is supplied to the input switching section 111.

The input switching section 111 executes a signal selection operation on the basis of a user operation. That is, the input switching section 111 supplies a video signal and audio signal of an input source (external device, broadcast wave) of selected one of the signals to the video/audio output section 112.

The video/audio output section 112 converts the video signal into a video signal of a format which can be displayed by the display 113, and appropriately adjusts the video signal in accordance with the screen size of the display 113. The video/audio output section 112 supplies the video signal to the display 113. The display 113 displays an image on the screen on the basis of the video signal. It should be noted that the video/audio output section 112 may be provided with an on-screen display function of characters, figures, and the like. The video/audio output section 112 generates a character signal by the on-screen display control of the main microcomputer 101. The video/audio output section 112 on-screen-displays characters on the display 113 by superimposing character signals on the video signal. Furthermore, the video/audio output section 112 amplifies the audio signal by sound-processing the audio signal into an audio signal of a format which can be reproduced by the speaker 114. The video/audio output section 112 supplies audio signals (L signal and R signal of a stereo) to the speaker 114. The speaker 114 outputs a sound on the basis of the audio signals. It should be noted that the video/audio output section 112 may be provided with a video mute circuit to be operated by the control of the main microcomputer 101 based on the user operation. At the time of muting, the video/audio output section 112 may not display the original video signal by starting the video mute circuit to thereby make the screen of the display 113 monochrome (e.g., blue-back).

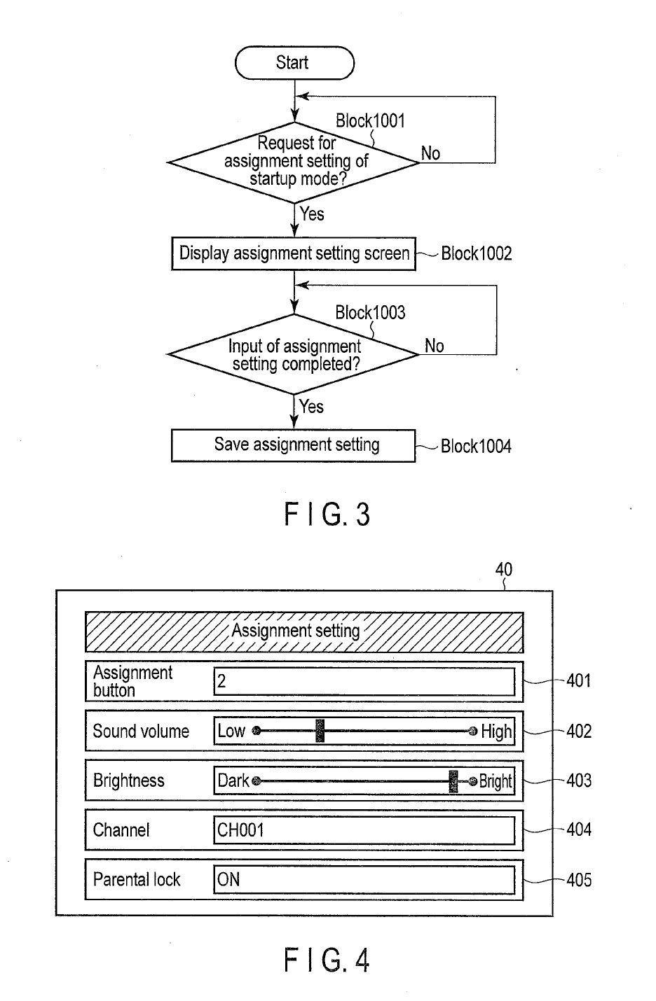

Next, assignment setting of the startup mode (hereinafter simply referred to as assignment setting) for buttons of the remote control 3 other than the power button 301 will be described below by using FIGS. 3, and 4. In this embodiment, it is assumed that the startup mode implies operation setting (operation setting mainly associated with video display and audio output) of a television receiver 1 to be carried out when the television receiver 1 makes a transition from a standby state to a startup state. The user carries out assignment setting in advance. FIG. 3 is a flowchart of processing of assignment setting which is an example according to the embodiment. FIG. 4 is an assignment setting screen 40 which is an example according to the embodiment.

The main microcomputer 101 determines whether or not a request for assignment setting has been received (Block 1001). The request for assignment setting is generated by selection of assignment setting prepared in a setting menu or the like based on the user operation of the remote control 3. When the main microcomputer 101 receives no request for assignment setting (No in Block 1001), the flow is returned to Block 1001, and the main microcomputer 101 waits for a request for assignment setting. When the main microcomputer 101 has received a request for assignment setting (Yes in Block 1001), the main microcomputer 101 starts the assignment setting screen 40 to display the screen 40 on the display 113 (Block 1002).

The assignment setting screen includes, as shown in FIG. 4, an assignment button setting (selection) box 401, sound volume setting box 402, brightness setting box 403, channel setting box 404, and parental lock setting box 405. The assignment button setting box 401 is a box used to set a button of the remote control 3 other than the power button 301 that is an object to which a desired startup mode is to be assigned. That is, a role different from a role at the time when the television receiver 1 is in the startup state is assigned to each of buttons of the remote control 3 other than the power button 301 when the television receiver 1 is in the standby state. It should be noted that although setting of a button which is an assignment object, and is a button of the remote control 3 other than the power button 301 is setting of a single button such as a button “2”, the setting is not limited to this. Setting of a button which is an assignment object, and is a button of the remote control 3 other than the power button 301 may be setting of an array of a plurality of consecutive buttons such as a button “2”, button “3”, button “1”, and button “4” as another example. The sound volume setting box 402 is a box used to set the sound volume to be output from the speaker 114 in the startup mode. The brightness setting box 403 is a box used to set the brightness of an image to be displayed on the display 113 in the startup mode. The channel setting box 404 is a box used to set a channel of an image to be displayed on the display 113 in the startup mode. It should be noted that the channel setting box 404 may be extended in such a manner that external input (e.g., the first HDMI terminal 109 or the second HDMI terminal 110) configured to capture input from an external device other than input from a broadcast wave channel can be set. It should be noted that the channel setting box 404 may be extended in such a manner that microcomputer-dependent setting, i.e., setting to be arbitrarily carried out by the main microcomputer 101 without setting a specific channel can also be set. The parental lock setting box 405 is a box used to set whether or not the parental lock function is to be rendered on or off in the startup mode.

The user can input setting of a desired startup mode to the assignment button on the assignment setting screen 40. The user can set different startup modes to different assignment buttons on the assignment setting screen 40. In the example shown in FIG. 4, a startup mode in which arbitrary sound volume, arbitrary brightness, a channel 001, and parental lock: ON are set is set to the button “2” which is the assignment button. It should be noted that in the assignment setting, although the assignment button setting box 401 is indispensable, the setting boxes 402 to 405 are only examples, and may be arbitrary if only they are boxes associated with setting of the operation of the television receiver 1, and are not limited to the examples. That is, it is sufficient if the assignment setting screen 40 includes at least one setting box for carrying out setting in connection with the operation of the television receiver 1 in addition to the assignment button setting box 401.

The main microcomputer 101 determines whether or not input of the assignment setting carried out by the user has been completed (Block 1003). When it determined by the main microcomputer 101 that no input of the assignment setting has been completed yet (No in Block 1003), the flow is returned to Block 1003, and the main microcomputer 101 waits for completion of input of the assignment setting. When it is determined by the main microcomputer 101 that input of the assignment setting has been completed (Yes in Block 1003), the main microcomputer 101 saves the assignment setting in the memory unit 102. That is, the main microcomputer 101 correlates a button provided on the remote control 3 other than the power button 301, and startup mode of the television receiver 1 set by the user with each other. For example, the main microcomputer 101 correlates one button of the remote control 3 other than the power button 301, and startup mode of the television receiver 1 set by the user with each other. For example, the main microcomputer 101 correlates an array of a plurality of consecutive buttons of the remote control 3 other than the power button 301, and startup mode of the television receiver 1 set by the user with each other. The memory unit 102 saves therein information about one or more assignment settings correlated by the main microcomputer 101. As the startup mode, for example, a manner mode in which the sound volume setting box 402 is set to low sound or mute, game mode in which the channel setting box 404 is set to an external input terminal to which a game machine is connected, and the like can be set in accordance with the taste of the user.

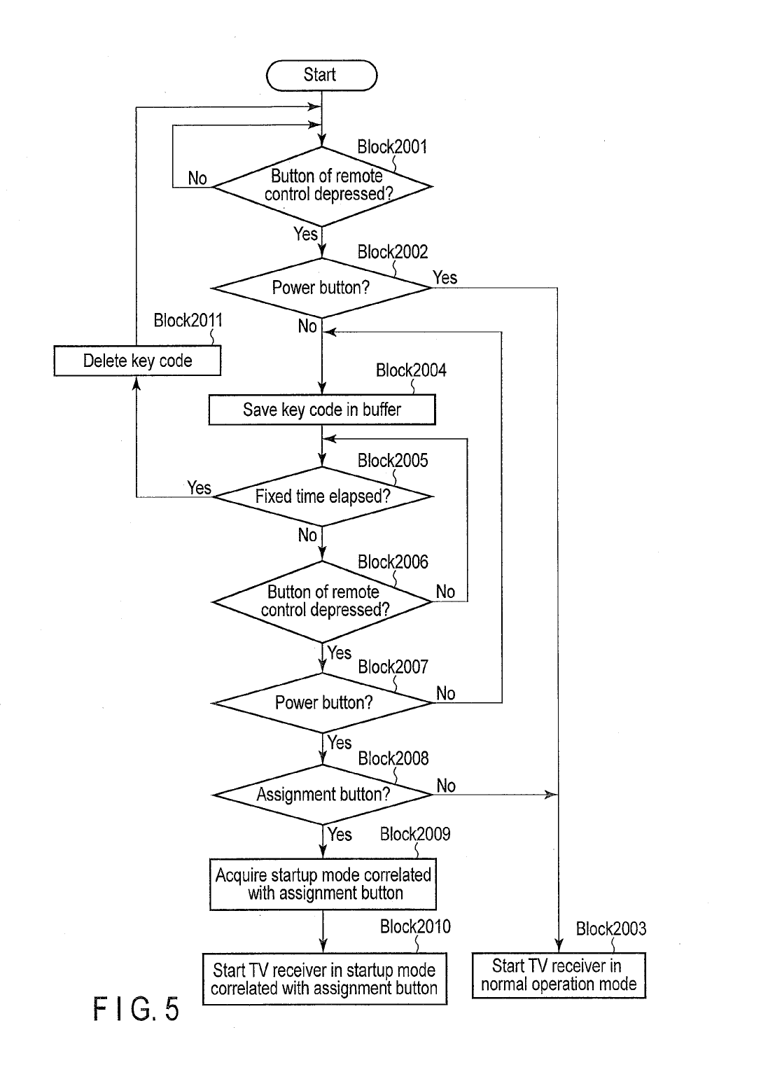

Next, an operation of the television receiver 1 to be carried out when the receiver 1 in the standby state makes a transition to the startup state will be described below. FIG. 5 is a flowchart of startup processing of the television receiver 1 which is an example according to the embodiment. Here, it is assumed that the television receiver 1 is in the standby state.

The sub-microcomputer 105 determines (confirms) whether or not a button of the remote control 3 has been depressed (Block 2001). In Block 2001, the sub-microcomputer 105 determines whether or not a button of the remote control 3 has been depressed on the basis of, for example, whether or not a key code has been supplied from the light receiving section 104. When it is determined by the sub-microcomputer 105 that no button of the remote control 3 has been depressed yet (No in Block 2001), the flow is returned to Block 2001, and the sub-microcomputer 105 waits for depression of a button of the remote control 3. When it is determined by the sub-microcomputer 105 that a button of the remote control 3 has been depressed (Yes in Block 2001), the sub-microcomputer 105 determines whether or not the depressed button is the power button 301 (Block 2002). In Block 2002, the sub-microcomputer 105 determines whether or not the depressed button is the power button 301, i.e., whether or not the power button 301 has been depressed by determining, for example, whether or not a key code corresponding to the depressed button coincides with a key code corresponding to the power button 301.

When it is determined by the sub-microcomputer 105 that the depressed button is the power button 301 (Yes in Block 2002), the main microcomputer 101 subjects the television receiver 1 to startup processing in the normal startup mode when the main microcomputer 101 causes the television receiver 1 to make a transition from the standby state to the startup state (block 2003). In this embodiment, it is assumed that the normal startup mode, implies the operation mode (operation setting associated mainly with video display and audio output such as sound volume, brightness, channel, on/off of parental lock, and the like) of the television receiver 1 immediately before (hereinafter referred to as the last state) the television receiver 1 has made a transition from the startup state to the standby state prior to the startup of this time. That is, when the television receiver 1 makes a transition from the standby state to the startup state, the receiver 1 displays an image on the display 113, and outputs a sound from the speaker 114 in the operation mode of the last state. It should be noted that in Block 2002, when the sub-microcomputer 105 determines whether or not the power button 301 has been depressed, and if it is determined that the power button 301 has been depressed, the sub-microcomputer 105 starts the main microcomputer 101 the operation of which is stopped. Accordingly, in Block 2003, the main microcomputer 101 starts by receiving a startup instruction from the sub-microcomputer 105, and subjects the television receiver 1 to startup processing in the normal startup mode by confirming that no key code corresponding to a button of the remote control 3 other than the power button 301 has been transmitted thereto from the sub-microcomputer 105.

When it is determined by the sub-microcomputer 105 that the depressed button is not the power button 301 (i.e., that the depressed button is a button of the remote control 3 other than the power button 301) (No in Block 2002), the sub-microcomputer 105 saves a key code corresponding to the depressed button of the remote control 3 other than the power button 301 in the buffer 1051 (Block 2004). The sub-microcomputer 105 refers to the timer 1052 to determine whether or not a fixed time T (e.g., about several seconds) has elapsed from the time at which the button of the remote control 3 other than the power button 301 has been depressed for the first time (Block 2005). In Block 2005, the sub-microcomputer 105 determines whether or not a fixed time T has elapsed from the time at which the button of the remote control 3 other than the power button 301 has been depressed for the first time by determining whether or not a fixed time T has elapsed from the time at which depression of the button of the remote control 3 other than the power button 301 has been detected for the first time.

When it is determined by the sub-microcomputer 105 that no fixed time has elapsed yet (No in Block 2005), the sub-microcomputer 105 determines whether or not a button of the remote control 3 has been depressed within a fixed time (Block 2006). In Block 2006, the sub-microcomputer 105 may determine depression of the button of the remote control 3 in the same manner as Block 2001. When it is determined by the sub-microcomputer 105 that no button of the remote control 3 has been depressed yet (No in Block 2006), the flow is returned to Block 2005, and the sub-microcomputer 105 determines whether or not a fixed time has elapsed. When it is determined by the sub-microcomputer 105 that a button of the remote control 3 has been depressed (Yes in Block 2006), the sub-microcomputer 105 determines whether or not the depressed button is the power button 301 (Block 2007). In Block 2007, the sub-microcomputer 105 may determine the depression of the power button 301 in the same manner as Block 2002. When it is determined by the sub-microcomputer 105 that the depressed button is not the power button 301 (i.e., that the depressed button is a button of the remote control 3 other than the power button 301) (No in Block 2007), the flow is returned to Block 2004, and the sub-microcomputer 105 saves a key code corresponding to the depressed button of the remote control 3 other than the power button 301 in the buffer 1051. That is, the buffer 1051 saves therein key codes of a number corresponding to the number of the depressed buttons. When it is determined by the sub-microcomputer 105 that the depressed button is the power button 301 (Yes in Block 2007), the main microcomputer 101 determines whether or not a button of the remote control 3 other than the power button 301 corresponding to one key code saved in the buffer 1051 or an array of buttons of the remote control 3 other than the power button 301 corresponding to a plurality of consecutive key codes is an assignment button or assignment buttons for which assignment setting has been carried out (Block 2008). It should be noted that when it is determined in Block 2007 by the sub-microcomputer 105 that the depressed button is the power button 301, i.e., when it is determined that the power button 301 has been depressed within a fixed time T, the sub-microcomputer 105 starts the main microcomputer 101 the operation of which is stopped. Furthermore, on the basis this determination, the sub-microcomputer 105 supplies one or more key codes saved in the buffer 1051 to the main microcomputer 101. Accordingly, in Block 2008, the main microcomputer 101 starts by receiving a startup instruction from the sub-microcomputer 105, and interprets a key code supplied thereto from the sub-microcomputer 105. For example, the main microcomputer 101 determines whether or not the above-mentioned button or buttons is an assignment button or are assignment buttons by comparing one button of the remote control 3 other than the power button 301 corresponding to one key code or an array of a plurality of buttons of the remote control 3 other than the power button 301 corresponding to a plurality of key codes, and an assignment button of each of assignment settings saved in the memory unit 102 with each other.

When it is determined by the main microcomputer 101 that the above-mentioned button or buttons is not an assignment button or are not assignment buttons (No in Block 2008), the main microcomputer 101 subjects the television receiver 1 to startup processing in the normal startup mode when the main microcomputer 101 causes the television receiver 1 to make a transition from the standby state to the startup state in Block 2003.

When it is determined by the main microcomputer 101 that the above-mentioned button or buttons is an assignment button or are assignment buttons (Yes in Block 2008), the main microcomputer 101 acquires a startup mode correlated with (set to) the assignment button or each of the assignment buttons from the memory unit 102 (Block 2009). The main microcomputer 101 subjects the television receiver 1 to startup processing in the startup mode correlated with the assignment button when the main microcomputer 101 causes the television receiver 1 to make a transition from the standby state to the startup state (Block 2010). That is, when the television receiver 1 makes a transition from the standby state to the startup state, the receiver 1 displays an image on the display 113, and outputs a sound from the speaker 114 in the startup mode desired by the user. It should be noted that although it is also possible to set an array of a plurality of consecutive buttons of the remote control 3 other than the power button 301 as assignment buttons as described above, this includes not only a role in making anyone other than the specific user unable to easily start setting of the particular startup mode, but also a role of an identification code of user authentication. Accordingly, it is possible to subject the television receiver 1 to startup processing in the startup mode correlated with the assignment button after carrying out user authentication on the basis of detection of depression of a plurality of consecutive buttons of the remote control 3 other than the power button 301.

It should be noted that when it is determined by the sub-microcomputer 105 that a fixed time T has elapsed (Yes in Block 2005), the sub-microcomputer 105 deletes (discards) the key code saved in the buffer 1051 (Block 2011). After that, the sub-microcomputer 105 returns to Block 2001, and waits for depression of a button of the remote control 3. The processing of Block 2011 is processing configured to prevent the sub-microcomputer 105 from transmitting the key code saved in the buffer 1051 to the main microcomputer 101 when it is determined by the sub-microcomputer 105 that the power button 301 has been depressed after an elapse of a fixed time T. It should be noted that the sub-microcomputer 105 may not carry out processing of Block 2011. In this case, it is sufficient if the sub-microcomputer 105 is made not to transmit the key code saved in the buffer 1051 to the main microcomputer 101 when it is determined by the sub-microcomputer 105 that the power button 301 has been depressed after an elapse of a fixed time T.

It should be noted that the transmission of the key code saved in the buffer 1051 from the sub-microcomputer 105 to the main microcomputer 101 may be based on a transmission instruction from the main microcomputer 101 which has received a startup instruction from the sub-microcomputer 105.

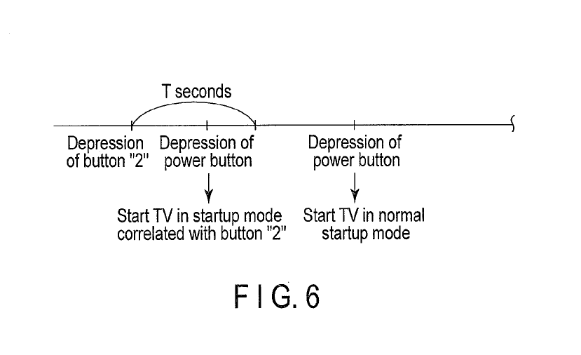

FIG. 6 is a view for explaining an example of the startup processing of the television receiver 1 explained in connection with FIG. 5. The user depresses a button (e.g., the button “2”) of the remote control 3 other than the power button 301, and set as an assignment button with which a startup mode of the user's preference is correlated. First, a case where the user has depressed the power button 301 within the fixed time T is assumed. When the power button 301 is depressed within the fixed time T from the time at which the button “2” has been depressed, the main microcomputer 101 starts the television receiver 1 in a startup mode correlated with the button “2”. Next, a case where the user has depressed the power button 301 after an elapse of the fixed time T is assumed. When the power button 301 is depressed after an elapse of the fixed time T, the main microcomputer 101 starts the television receiver 1 in the standby state not in the startup mode correlated with the button “2”, but in the operation mode of the last state.

It should be noted that in the above description using FIGS. 5 and 6, although the main microcomputer 101 determines whether a startup mode correlated with an assignment button is to be used or a normal startup mode is to be used by using the fixed time T, the determination of the main microcomputer 101 is not limited to this. That is, when the television receiver 1 is in the standby state, a button of the remote control 3 other than the power button 301 is depressed, the button being a button for which assignment button setting has already been carried out, and thereafter the power button 301 is depressed, the main microcomputer 101 may start, in the startup mode correlated with this assignment button, the television receiver 1 in the standby state regardless of whether or not the fixed time T has elapsed.

As another embodiment, the LED unit 106 may carry out notification under the control of the sub-microcomputer 105 within a fixed time T from the time at which a button of the remote control 3 other than the power button 301 has been depressed to the time at which the power key is depressed or until the fixed time T elapses when the power key is not depressed within the fixed time T. For example, when the LED unit 106 is provided with only LEDs of a single color, the LED unit 106 operates by carrying out high-speed blinking or the like different from the operation to be carried out when the television receiver 1 is in the standby state, and operation to be carried out when the television receiver 1 is in the startup state. For example, when the LED unit 106 is provided with LEDs of a plurality of colors, the LED unit 106 lights up in a color different from the color to be exhibited when the television receiver 1 is in the standby state, and color to be exhibited when the television receiver 1 is in the startup state. It should be noted that regarding the notification method, it is sufficient if it is possible to notify the user that a button of the remote control 3 other than the power button 301 is depressed. In place of the notification by the LED unit 106, notification by sound may be employed, and the notification method is not limited to the above.

As another embodiment, the main microcomputer 101 may correlate each assignment button with a user for whom the assignment button is intended at the time of assignment setting on the basis of the user input, and may save the correlation information in the memory unit 102. In this case, the main microcomputer 101 can save the viewing history (including the history of reproduction from external devices) obtained after subjecting the television receiver 1 to startup processing in an operation mode corresponding to the assignment button as a viewing history of the user correlated with the assignment button in the memory unit 102. At the time of startup of the television receiver 1 based on the depression of the assignment button, when the channels are left up to the microcomputer-dependent setting, the main microcomputer 101 identifies a user correlated with the assignment button. Further, the main microcomputer 101 can display a program image of a channel or an external input image most suitable for the date/time on/at which the television receiver 1 has been subjected to startup processing in a startup mode correlated with the assignment button on the display 113 in accordance with the viewing history of the identified user. Accordingly, the user can entrust display of an image (program frequently viewed by the user) most suitable for himself or herself to the television receiver 1.

According to this embodiment, it is possible for the television receiver 1 to realize function enhancement without adding additional hardware resources to the remote control 3. Furthermore, the user can start the television receiver 1 in a state corresponding to the user's taste simultaneously with issuance of an instruction to start the television receiver 1, and hence the user need not carry out a troublesome operation after starting the television receiver 1 in the standby state. Furthermore, a plurality of assignment settings can be used for different time periods or can be used for different users, and hence the convenience of the user is improved. Examples of appropriate use are shown below. In the time period of midnight, it is advisable for the user to start the television receiver 1 by depressing an assignment button correlated with a startup mode of the manner mode. When a video game is to be started, it is advisable for the user to start the television receiver 1 by depressing an assignment button correlated with a startup mode of the game mode. When a news program is to be viewed, it is advisable for the user to start the television receiver 1 by depressing an assignment button correlated with a startup mode to which a channel for broadcasting the news program is set. It is advisable for a parent to start the television receiver 1 by depressing an assignment button correlated with a startup mode for which parental lock is set to off.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image display device comprising:
a first control section configured to correlate a non-power button with a startup mode of the image display device, the non-power button being provided on a remote controller, and the startup mode being configured to be set by a user; and
a first storage section configured to save information on a correlation established by the first control section.

2. The image display device of claim 1, wherein
the non-power button includes a particular button other than a power button, and
the first control section starts the image display device in the startup mode being correlated with the particular button, when the particular button is depressed or activated while the image display device is in a standby state, and if the power button is depressed or activated.

3. The image display device of claim 2, wherein the first control section starts the image display device in the startup mode being correlated with the particular button, when the power button is depressed or activated within a predetermined period of time starting from the depression or activation of the particular button.

4. The image display device of claim 3, wherein when the power button is depressed or activated after elapsing the predetermined period of time, the first control section starts the image display device in an operation mode immediately before the image display device has been brought to the standby state.

5. The image display device of claim 3, further comprising
a notification section configured to carry out notification from the time at which the particular button has been depressed or activated to the time at which the power button is depressed or activated.

6. The image display device of claim 1, wherein the first control section correlates an array of buttons with the startup mode set by the user, the array of buttons being different from a power button.

7. The image display device of claim 2, wherein
the first control section identifies the user correlated with the particular button when the image display device is started, and displays a program of a channel corresponding to a viewing history of the identified user on a display.

8. The image display device of claim 4, further comprising:
a second control section configured to determine whether or not the power button has been depressed or activated, and to start the first control section when it is determined by the second control section that the power button has been depressed or activated; and
a second storage section configured to save information on the depressed or activated particular button when it is determined by the second control section that the power button has not been depressed or activated.

9. The image display device of claim 8, wherein
when it is determined by the second control section that the power button has been depressed or activated within the predetermined period of time, the second control section supplies the first control section with information on the particular button saved in the second storage section.

10. A starting method comprising:
correlating a non-power button with a startup mode of an image display device, the non-power button being provided on a remote controller and including a particular button other than a power button, and the startup mode being configured to be set by a user; and
starting the image display device in the startup mode correlated with the particular button, when the image display device is in a standby state, the particular button is depressed or activated, and thereafter the power button is depressed or activated.
